(19) United States
(12) Patent Application Publication
(10) Pub. No.: US 2026/0130811 A1
(43) Pub. Date: May 14, 2026

(54) JAW STRETCHING DEVICE

(71) Applicants: Lifehouse Australia, Camperdown, New South Wales (AU); Sydney Local Health District, Camperdown, New South Wales (AU)

(72) Inventors: Jonathan Clark, Camperdown, New South Wales (AU); Kai Cheng, Ermington, New South Wales (AU); Emma Charters, Rozelle, New South Wales (AU)

(21) Appl. No.: 18/865,885

(22) PCT Filed: May 17, 2022
(86) PCT No.: PCT/AU2022/050474

§ 371 Date: Nov. 14, 2024

(51) Int. Cl. A61H 1/02; A63B 23/03; B33Y 70/10; B33Y 80/00

(52) U.S. Cl. CPC A61H 1/02; A63B 23/032; B33Y 70/10; B33Y 80/00; A61H 2201/1253; A61H 2201/1261; A61H 2201/1604; A61H 2205/026

(57) ABSTRACT

The present invention relates to a device and method for the treatment of trismus. The device comprises: a frame including two arms connected to a base portion; a first insert locatable in the frame, the first insert configured to cause the two arms to exert a first predetermined force in opposing outward directions relative to a central axis of the device; a second insert locatable in the frame in the same position as the first insert, the second insert configured to cause the two arms to exert a second predetermined force in opposing outward directions relative to the central axis of the device.

### TECHNICAL FIELD

The present disclosure relates to a jaw stretching device, in particular for treatment of trismus and other temporomandibular joint disorders.

### BACKGROUND OF THE DISCLOSURE

Trismus is a condition which involves restriction of the range of motion of the jaws, usually due to spasms in the muscles of mastication (the group of muscles responsible for the chewing movement of the jaw). While definitions vary, trismus is commonly quantified by the ‘three-finger test’ where trismus diagnosis is made if a patient cannot fit three fingers vertically stacked between their teeth, or if the maximum mouth opening is less than 35 mm. Trismus can result from a number of causes including (but not limited to): tetanus (where the condition is sometimes known as lockjaw), seizures, traumatic brain injuries, and following head and neck surgery or radiotherapy for head and neck cancer patients. Trismus is experienced by approximately 38 to 44% of people treated for head and neck cancer and so obtaining an effective treatment for trismus is of particular interest in this field.

Trismus can be temporary or permanent. Being unable to properly open the mouth may prevent a person with trismus from performing many everyday tasks, such as speaking, eating, and brushing their teeth/receiving professional dental care. In some cases, trismus may even compromise the airway of a patient. As a result, trismus may lead to poor nutrition, dental health and disfigurement, as well as poorer mental health outcomes, social isolation, financial loss, and/or loss of employment, especially in longer term cases.

One treatment for trismus is performing jaw stretching exercises. For example, when a patient is undergoing radiotherapy of the head or neck, these exercises, often referred to as range of motion (ROM) exercises can be carried out preventatively (prior to radiotherapy), following radiotherapy, or as maintenance over the longer term. To aid in stretching of the jaw, sometimes stacked tongue depressors (also referred to as tongue blades) or wooden spatulas are placed in the mouth of the patient to apply force to open the mouth.

A number of issues exist with the use of stacked tongue depressors. Firstly, there is no way to calibrate the amount of force being applied for each set of depressors, and the applied force may vary depending on the type and shape of the depressors and the placement of said depressors in the patient's mouth. There is also no way to regulate or alter the force of the stacked tongue depressors. The stacked tongue depressors can apply rough forces to the TMJ and teeth, a problem which is compounded following radiotherapy as the teeth and jaw can be more brittle than normal. This is also a problem following complex jaw reconstructions where too much force can re-fracture the jaw. Accordingly, it is possible to accidentally cause damage to the patient's teeth and jaw, furthering the patient's difficulty using their mouth, rather than treating the patient's trismus.

One solution to this is the ARK-J stretching device developed by Brian Kanapkey and Byron Kubik, which is still made from tongue depressors, but rather than simply being stacked on each other, some depressors are cut and stacked together, before uncut depressors are placed above and below the stack so that they extend further than the stack. In this way, the top and bottom depressors can be placed in the patient's mouth as with the stacked tongue depressors but provide more give relative to the stacked depressors, making them less likely to impart dangerous forces to the patient. The ARK-J device can be used for both passive stretching (like the stacked tongue depressors), as well as active stretching (where the patient is instructed to bite down on the ends of the top and bottom depressor repeatedly to exercise the muscles of mastication). As the ARK-J device is made from tongue depressors and tape, there is still variability across devices in the force applied, and no way to calibrate or vary the amount of force applied.

Another attempts at providing a safer alternative to the stacked tongue depressor method has resulted in commercially available devices such as Therabite® Jaw Motion Rehabilitation System™, the Dynasplint Trismus System®, and the Orastretch® Press Device. These devices typically include two bite pads which a user inserts between their upper and lower teeth and a means for increasing the distance between these bite pads to open the jaw, such as a scissor-like handle which the patient can bring together to force the bite pads apart. Often a way of setting a maximum opening distance is provided. Over the course of treatment, the maximum opening distance can be increased and the patient's mouth opened wider as they gain strength. These commercially available products, however, have a number of issues. Their designs are only capable of passive stretching in the same manner as the stacked tongue depressors, despite being less likely to cause injury to a patient. They are also far more expensive compared to the stacked tongue depressors and ARK-J homemade devices.

Embodiments of the present invention seek to solve at least some of the problems associated with current devices for the treatment of trismus.

### SUMMARY OF THE INVENTION

In a broad first aspect, there is a device for the treatment of trismus, comprising: a frame including two arms connected to a base portion; a first insert locatable in the frame, the first insert configured to cause the two arms to exert a first predetermined force in opposing outward directions relative to a central axis of the device; a second insert locatable in the frame in the same position as the first insert, the second insert configured to cause the two arms to exert a second predetermined force in opposing outward directions relative to the central axis of the device.

In certain embodiments of the first aspect, the two arms exert an initial predetermined force in opposing outward directions relative to a central axis of the device when no insert is attached.

In certain embodiments of the first aspect, the first and second inserts can be attached to the frame in multiple positions, the attached insert causing the two arms to exert a different predetermined force in opposing directions relative to the central axis at each position.

In certain embodiments of the first aspect, the maximum displacement forces imparted by the device are in the range of 10-100 N.

In certain embodiments of the first aspect, the device further comprises mouth guards which are located at an end of each arm to contact the mouth of the patient.

In certain embodiments of the first aspect, the first and second insert are locatable in the frame between the two arms.

In certain embodiments of the first aspect, the inserts are locatable in the frame by corresponding protrusions and recesses on the frame and inserts.

In certain embodiments of the first aspect, the frame is U-shaped.

In certain embodiments of the first aspect, the frame has a length between 115 and 155 mm, a total width between 47 and 57 mm, and a thickness between 6 and 10 mm.

In certain embodiments of the first aspect, the inserts are U-shaped, and have a protrusion on an outer edge of an insert arm of each insert, and the frame has a series of recesses shaped to match said protrusions on an inner surface of each arm.

In certain embodiments of the first aspect, the frame has three recesses on each arm and the device has three positions in which the insert can be located.

In certain embodiments of the first aspect, in the insert arms of the second insert have a greater width than the insert arms of the first insert.

In certain embodiments of the first aspect, each insert has a length between 32.5 and 42.5 mm, a total width between 33.4 and 43.4 mm; wherein the insert arms of the first insert have a width of 2.8 mm and the insert arms of the second insert have a width of 4.2 mm.

In certain embodiments of the first aspect, at least one of the frame, mouthguard or the inserts is manufactured using 3D printing.

In certain embodiments of the first aspect, the material of at least one of the frame or inserts manufactured using 3D printing is selected from: Polylactic Acid (PLA), Polyethylene Terephthalate (PETG), nylon, or poly ether ether ketone (PEEK).

In certain embodiments of the first aspect, the material of at least one of the frame or inserts manufactured using 3D printing has anti-bacterial properties, such as copper nanoparticle impregnated PLA.

In certain embodiments of the first aspect, the material of the mouthguard is surgical grade resin.

According to a second broad aspect, there is provided an insert for use with the first aspect.

According to a third broad aspect, there is provided a mouthguard for use with the first aspect.

According to a fourth broad aspect, there is provided a method for the treatment of trismus, comprising: using a device according to the first aspect to exercise the jaw of a patient by placing the arms of the device into the patient's mouth opening such that the arms apply forces against the upper and lower jaw of the patient.

In certain embodiments of the fourth aspect, using the device includes asking the patient to repeatedly bite down on the arms of the device to actively stretch the muscles of mastication.

In certain embodiments of the fourth aspect, wherein using the device to exercise the jaw of a patient comprises using the device with the first insert attached in a first position in a first stage of treatment, then using the device with the first insert attached in a second position in a second stage of treatment.

In certain embodiments of the fourth aspect, the method further comprises using the device with the second insert attached in the first position in a third stage of treatment, and then using the device with the second insert attached in the second position in a fourth stage of treatment.

Other aspects, features, and advantages will become apparent from the following detailed description when taken in conjunction with the accompanying drawings, which are a part of this disclosure and which illustrate, by way of example, principles of the inventions disclosed.

### BRIEF DESCRIPTION OF THE FIGURES

The present disclosure will become better understood from the following detailed description of various non-limiting embodiments thereof, described in connection with the accompanying figures, wherein:

FIG. 1 shows an embodiment of the jaw stretching device according to the present invention.

FIG. 2 shows a diagram of two frames of an embodiment of the jaw stretching device according to the present invention.

FIG. 3 shows a plan view of two inserts for an embodiment of the jaw stretching device according to the present invention.

FIG. 4 shows two sets of mouth guards for embodiments of the jaw stretching device according to the present invention.

### DETAILED DESCRIPTION

The present invention relates to a jaw stretching device for the treatment of trismus and other similar conditions. The device includes a frame, the frame having two arms which can be inserted into the mouth opening of a patient to provide resistance forces against the upper and lower jaw (the maxilla and mandible respectively) by contacting the upper and lower teeth of a patient (preferably the incisors), and a base portion to which both arms are connected. In preferred embodiments, the frame has a substantially U-shaped appearance, with the base portion connecting the two arms at one end. This base portion may be curved inwardly in order to aid in providing the required forces at the end of the arms, however it will be understood that in other embodiments, the base portion may be straight or may curve outwardly and have cut out portions to provide the required resistance against the patient's teeth.

In some preferred embodiments, mouth guards may be fitted to the ends of the two arms on the frame where the arms would contact the mouth or teeth of a patient. These can be made from biocompatible materials such as surgical-grade resin and act to ensure that the device remains hygienic during use.

The frame and mouth guards can be used to exercise the muscles of mastication and stretch the jaw of a patient. The frame is designed so that the combination of shape and chosen material produces a predetermined resistance force against the maxilla and mandible to open it. This frame may be used for passive stretching, that is to say, jaw exercises where the patient inserts the arms into their mouth and allows the two arms to apply the resistance forces against their maxilla and mandible to stretch the mouth in an open position. The frame can also be used for active stretching, in which following inserting the arms into their mouth, the patient practices biting down on the arms and releasing them repeatedly. In this method, the arms of the device provide an increasing resistance force against the maxilla and mandible as the patient applies a bite force against the arms. Both forms of stretching may be used either alone or in conjunction with each other as part of a treatment for trismus.

The frame and mouth guards preferably impart a low predetermined resistance force which can be used either early on in the treatment process and/or when the mouth opening is restricted to a large degree, and/or when the patient's teeth and bones are weakened or brittle. This low maximum force imparted to the maxilla and mandible ensures that the patient does not suffer harm to their jaw during stretching even when their muscles of mastication are weakened or bones are brittle.

The device also includes multiple inserts which can be located inside the frame to increase the amount of force exerted by the arms. In preferred embodiments, these inserts are also substantially U-shaped, and locate between the arms to increase the spacing between the two arms. Each insert is configured to cause the arms to apply a different predetermined resistance force. This means that for patients with a less restricted mouth opening, or for patients later in the course of treatment (where the patient's muscles of mastication have strengthened), higher forces can be applied. As each insert is associated with a single maximal displacement force, a medical professional such as the patient's surgeon/speech pathologist/prosthodontist can instruct the patient to use a specific insert to stretch their jaw, as well as when to switch to another insert, typically with a greater amount of force. Preferably, the range of forces which are applied by the invention are in the range of 10-100 N, so as to not cause any damage to the patient's jaw during the rehabilitation process.

The arrangement of inserts and frame allows for a graduated range of forces which can be applied to the patient's jaw. The amount of force being applied can be stepped up or down by altering the inserts. Each of these forces are chosen to be safe to apply to a patient's jaw. Thus, the displacement force applied to the jaw can be incrementally increased across the treatment in line with exercise physiology principles. By basing the different insert/positions on the resultant maximum displacement force rather than an interincisal distance, the device may be less likely to impart an incorrect (and potentially dangerous) force to the patient's jaw. The inserts may be coloured differently from each other to enable the easy identification of the correct insert by a patient. For example, a first insert for an initial stage of treatment may be coloured green, and a second insert for a later stage of treatment coloured red so that the patient may be instructed to use the green insert, before being instructed to swap to the red insert when the medical professional deems it appropriate.

In preferred embodiments, the inserts are locatable in the frame in multiple positions. Each insert and position results in a different predetermined resistance force being applied. As a result, a larger number of forces across the total range can be applied to the patient's mouth. Otherwise stated, the device can exert a series of forces with each insert by placing the insert in different positions. This provides a more granular series of forces than would otherwise be available, while ensuring that the maximal force for each insert is not large enough to cause potential harm. This allows a patient, under the instruction of a medical professional, to incrementally increase the force being applied to their jaw over the course of treatment. The patient can thus continue to apply an appropriate amount of force to their jaw as their muscles of mastication strengthen over the course of treatment.

In preferred embodiments, at least one of the frame, mouthguard and inserts are made by additive manufacturing processes, otherwise referred to as 3D printing. As there are no springs or moving parts required, the device can be made cheaply and quickly on most commercially available printers without difficulty. Compared to existing devices, the present device can be manufactured faster, cheaper, and in greater quantities. Unlike other easily made improvised devices like stacked tongue depressors, each device applies the same predetermined forces, so a medical professional can ensure the right forces are applied to the patient.

The present disclosure will become better understood from the following example of a non-limiting embodiment.

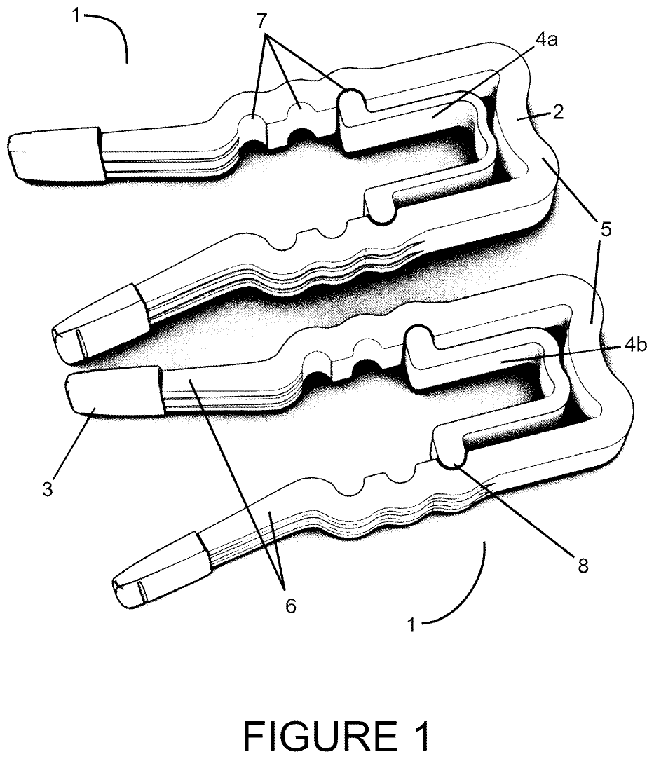

FIG. 1 shows an embodiment of two jaw stretching devices 1. Each device includes a frame 2, mouth guards 3 and insert 4a, 4b which are located in a first position in the frame.

The frame consists of a base portion 5 and arms 6. The frame has an overall U-shaped appearance, with the arms extending from the base portion 5. The arms consist of two separate regions, a proximal region connected to the base portion 5 and a distal portion at a free end of each arm. The proximal regions in this embodiment extend substantially perpendicularly to the base portion and substantially parallel to each other, while the distal region of each arm extends at an outward angle relative to a central axis of the frame. The arms of this embodiment also each include three recesses or notches 7 on an inner surface of their proximal regions which face each other. These are used to locate the inserts 4a, 4b, in three separate positions within the frame. The base portion 5 bows inwardly towards the interior of the frame. Otherwise stated, the base portion has a concave region between where the base portion connects to the arms. The shape and geometry of the base portion may assist in creating the necessary forces at the distal ends of the arms. It will be understood that in other embodiments, different geometries of the base portion may be used to accomplish the same function. For example, the base portion may instead bow outwardly, with cut out portions on alternating sides of the base portion to provide the necessary give/resistance.

The inserts 4a, 4b are also substantially U-shaped in this embodiment, however they are sized to fit within the interior of the frame. Accordingly, they may have a concave base to match the base portion 5 of the frame 2, and two arms which extend substantially parallel to each other and to the proximal portions of the arms 6. The inserts in this embodiment have a protrusion or bump 8 on each of the outer edges of the insert which is sized to match the notches 7 on the inner surface of the arms 6 of the frame. The insert can thus be slid or otherwise placed so that the protrusions and notches align to locate the insert within the frame. In this embodiment, where there are three notches on an inner surface of each arm, there are thus three separate and distinct ways in which each insert can be located within the frame. Placing the insert in each location results in a different force being applied by the distal portions of the arms outwards relative to a central axis of the device. It will be understood that in other embodiments, there may be more or fewer notches on the frame, resulting in more or fewer positions in which the insert may be located. Further, it will be understood that in other embodiments, the protrusions may not be located at the outer edge of the insert. For example, the protrusions may instead be located on an outer surface of the insert closer to the concave portion, or the frame may instead include protrusions on an inner surface and the inserts instead including notches which co-operate to locate the insert in the frame in a similar manner. It will further be understood that in other embodiments, other known temporary fastening or locating methods may be used to locate the insert in the frame.

In this embodiment, insert 4b is configured to induce a higher resistance force outwardly from the arms of the device (which contact the upper and lower teeth of a patient through mouth guards 3) than insert 4a. This is achieved through manufacturing insert 4b with a higher thickness than insert 4a, reducing the amount of give when a patient bites down on mouth guards 3 and increasing the resistance force applied to the patient's jaw. As each insert 4a or 4b can be placed in the same three positions (due to co-operating notches and protrusions) in this embodiment, this creates seven potential levels of resistance force from this one device with two inserts (given that the frame also exerts a force when no insert is inserted)

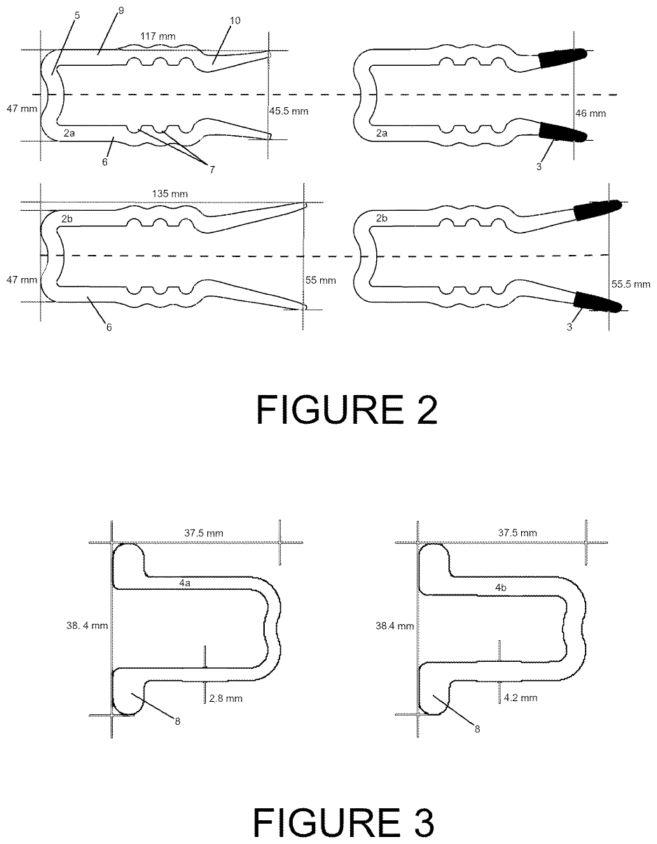

The predetermined forces applied by the device may be fine-tuned by a combination of the shape or geometry of the device and the inserts, and the material used in the construction. FIGS. 2 and 3 show plan views of two frames frame/mouth guards and inserts respectively. For ease of reference, the same reference numerals are used for the remaining figures as for FIG. 1.

FIG. 2 shows two separate frames 2a and 2b, with and without mouth guards 3 attached. Each frame comprises a base portion 5 and arms 6. The arms 6 can be divided into a proximal region 9 and a distal region 10. The distal region extends at an angle relative to the central axis (represented by the dashed line) while the proximal region is substantially parallel to the central axis. The proximal region also includes notches 7 for attaching inserts.

In this plan view, it can be seen that frame 2a has a length of 117 mm and frame 2b has a length of 135 mm. Both frames have a width at the base portion of 47 mm, and a width at the opposing end of 45.5 mm and 55 mm respectively. It can be seen that with the mouth guards 3 attached, this width increases to 46 mm and 55.5 mm respectively. In preferred embodiments, the frame is 3D printed using commercially available 3D printable polymers such as but not limited to: polylactic acid (PLA), polyethylene terephthalate glycol (PETG), nylon, or poly ether ether keyone (PEEK). It will be understood that other 3D printable polymers may be used, provided that they are safe for insertion into a patient's mouth opening. As an example, the frame can be manufactured using a commercially available 3D printer using the following parameters: a layer thickness of 0.3±0.2 mm, an infill of 50-100%, with the shell being 3±2 layers, and the top and bottom layers being 5±2 layers. The produced frame can have the following dimensions: a length of 135±20 mm a width of 52±5 mm a height of 18±5 mm, and an arm/base portion thickness of 8±2 mm.

Referring now to FIG. 3, the dimensions of two inserts 4a and 4b are shown. In order to be locatable in the frame, the overall dimensions of the inserts 4a and 4b are substantially the same, so that protrusions 8 on the outer edges of each insert are in substantially the same location when placed in corresponding notches on the frame. Both inserts thus have a length of 37.5 mm and a height of 38.4 mm as measured between the ends of the protrusions 8. Where the two inserts differ is in the thickness of the insert. Insert 4a has a thickness of 2.8 mm while insert 4b has a thickness of 4.2 mm. As a result, insert 4b will provide a higher range of resistance forces when inserted in the frame relative to insert 4a.

The inserts may be made in some embodiments be made from the same material as the frame and, in the embodiments where the frame is 3D printed, be printed with the same material on the same machine. Similar materials may thus be appropriate for the inserts as for the frame. An example of 3D printer parameters suitable for manufacturing the inserts are: a later thickness of 0.25 mm, an infill of 50-100%, a shell of 3±3 layers, the top layers being 5±2 layers, and the bottom layers being 5±2 layers. The produced inserts can have the following dimensions: a length of 37.5±5 mm, an overall width of 38.4±5 mm, and a height of 18±5 mm. The thickness will of course depend on the desired force, but will be in a range between 2.0-6.0 mm.

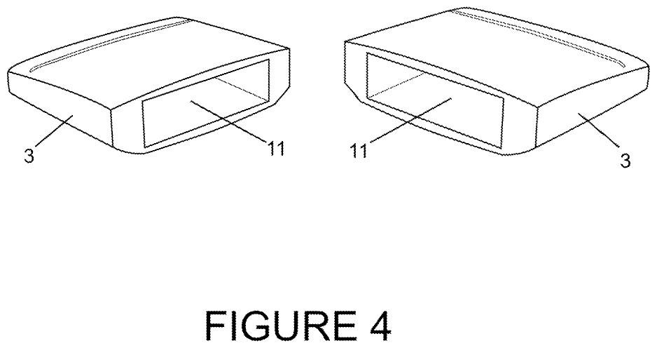

FIG. 4 shows an embodiment of a set of mouth guards for a jaw stretching device according to the present invention. In this embodiment, the mouth guards are made from surgical grade resin and have a length of 24.5 mm, a width of 25.5 mm, a height at the end proximal the arms of 8 mm, and a height at a distal end of 5 mm. In this embodiment, the mouth guards include an opening 11 which is sized to fit the distal end of the arm of the frame. As a result, the mouth guards can be friction fit or pressure fit onto the arms of the frame. This allows for the easy assembly of a device according to the present invention, without the need for tools or specific knowledge. This also means that the mouth guards may be kept separate, in a sterile or hygienic environment, prior to use, as the mouth guards are the part of the device which contact the mouth of a patient. It will be understood that in other embodiments, the mouth guards may be glued or otherwise attached to the frame.

As with the insert and frame, the mouth guards are also designed to be 3D printable. Given that the mouth guards contact the interior of the patient's mouth, they need to be made from a safe biocompatible 3D printable material such as surgical grade resin. A 3D printer may be used to produce a set of mouth guards with the following dimensions: a length of 24.5±5 mm, a width of 25.5±5 mm, and a height that tapers from 8±2 mm at the back (towards the device) to 5±2 mm at the front (towards the patient), with the mouth guards being 3D printed with a layer thickness of 0.1 mm. As well as being 3D printable, it may also be advantageous to sell the device as a kit comprising the frame, inserts, and mouth guard.

In order to assess the forces generated by the novel invention, the inventors carried out force displacement tests on embodiments of the device similar to those described above with two inserts (a first insert with a thickness of 2.4 mm and a second insert with a thickness of 4.2 mm) and three positions in which each insert can be inserted in the frame. The maximal force was determined assuming an incisal bite force of 200 N. The inventors tested the device with no insert in place (frame only), then both inserts in all three positions. The maximal force generated by each insert is tabulated below:

Max Force (N)

| | | Insert with | Insert with |
|---|---|---|---|
| Insert | | 2.4 mm | 4.2 mm |
| position | Frame Only | thickness | thickness |
| 1 | — | 29.5 | 36.8 |
| 2 | 26.2 | 34.1 | 48.3 |
| 3 | — | 41.8 | 66.9 |

These results show that a series of forces between approximately 25 and 70 N can be generated by the device to safely guide patients through a trismus rehabilitation. This can be done by incrementally stepping up the resistance force generated by the device by altering the insert position and choice of insert. These forces are suitable for both stretching the jaw opening and strengthening the muscles of mastication, two functions required for trismus rehabilitation. These forces are also outside of the range of forces which may cause any damage to the jaw of the patient.

The same design was used to conduct a pilot study on patients with trismus (defined by an interincisal distance (IID) of less than 35 mm). The participants underwent a 10-week individualized program using the device and measures were taken of the IID pre and post therapy, as well as quality of life measures.

The mean IID prior to therapy was 17.6 mm (a range of 2-30 mm), and the mean IID post therapy was 30.2 mm (a range of 15-50 mm). The mean increase in IID was 11.5 mm. On completion of the study, eight (representing 47%) of the participants no longer met the diagnostic criteria for trismus. Further, there was a statistically significant improvement in trismus related quality of life (p=0.02); swallowing as measured by the MD Anderson Dysphagia Inventory or MDADI (p=0.006); speech, as measured by the Speech Handicap Index or SHI (0.02) and pain; (p=0.001) when comparing pre-vs post-intervention scores and adjusting for baseline.

The present jaw stretching device has a number of potential advantages over current methods and devices for the treatment of trismus. Firstly, the present device allows for a quantified and standardized maximum displacement force across all devices for the same inserts and positions. This differs from existing devices which instead set a maximum intericisal distance rather than a different maximum displacement force. This means that a patient is less likely to expose their jaw to dangerously large forces during the rehabilitation process. Further, the present device has the capability to incrementally increase the displacement force by swapping the insert/position of the insert, aiding in following exercise physiology principles. The device is also easy to use, and, by not requiring moving parts or springs like existing devices, can be made at relatively low cost. In particular, when the device is 3D printed, the speed and ease of manufacture is greater than existing devices as well. The device also allows for both passive stretching as well as the active exercise of the muscles of mastication.

In the foregoing description of certain embodiments, specific terminology has been resorted to for the sake of clarity. However, the disclosure is not intended to be limited to the specific terms so selected, and it is to be understood that each specific term includes other technical equivalents which operate in a similar manner to accomplish a similar technical purpose.

In this specification, the word “comprising” is to be understood in its “open” sense, that is, in the sense of “including”, and thus not limited to its “closed” sense, that is the sense of “consisting only of”. A corresponding meaning is to be attributed to the corresponding words “comprise”, “comprised” and “comprises” where they appear.

The reference in this specification to any prior publication (or information derived from it), or to any matter which is known, is not, and should not be taken as, an acknowledgement or admission or any form of suggestion that prior publication (or information derived from it) or known matter forms part of the common general knowledge in the field of endeavour to which this specification relates.

In addition, the foregoing describes only some embodiments of the invention(s), and alterations, modifications, additions and/or changes can be made thereto without departing from the scope and spirit of the disclosed embodiments, the embodiments being illustrative and not restrictive.

Furthermore, invention(s) have described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the invention(s). Also, the various embodiments described above may be implemented in conjunction with other embodiments, e.g., aspects of one embodiment may be combined with aspects of another embodiment to realize yet other embodiments. Further, each independent feature or component of any given assembly may constitute an additional embodiment.

1. A device for the treatment of trismus, comprising:
a frame including two arms connected to a base portion;
a first insert locatable in the frame, the first insert configured to cause the two arms to exert a first predetermined force in opposing outward directions relative to a central axis of the device;
a second insert locatable in the frame in the same position as the first insert, the second insert configured to cause the two arms to exert a second predetermined force in opposing outward directions relative to the central axis of the device.

2. The device according to claim 1, wherein the two arms exert an initial predetermined force in opposing outward directions relative to a central axis of the device when no insert is attached.

3. The device according to claim 1, wherein the first and second inserts can be attached to the frame in multiple positions, the attached insert causing the two arms to exert a different predetermined force in opposing directions relative to the central axis at each position.

4. The device according to claim 1, wherein the maximum displacement forces imparted by the device are in the range of 10-100 N.

5. The device according to claim 1, further comprising mouth guards which are located at an end of each arm to contact the mouth of the patient.

6. The device according to claim 1, wherein the first and second insert can be located in the frame between the two arms.

7. The device according to claim 1, wherein the inserts are locatable in the frame by corresponding protrusions and recesses on the frame and inserts.

8. The device according to claim 1, wherein the frame is U-shaped.

9. The device according to claim 8, wherein the frame has a length between 115 and 155 mm, a total width between 47 and 57 mm, and a thickness between 6 and 10 mm.

10. The device according to claim 9, wherein the inserts are U-shaped, and have a protrusion on an outer edge of an insert arm of each insert, and the frame has a series of recesses shaped to match said protrusions on an inner surface of each arm.

11. The device according to claim 10, wherein the frame has three recesses on each arm and the device has three positions in which the insert can be located.

12. The device according to claim 10, wherein the insert arms of the second insert have a greater width than the insert arms of the first insert.

13. (canceled)

14. The device according to claim 1 wherein at least one of the frame, mouthguard or the inserts is manufactured using 3D printing.

15. The device according to claim 14, wherein the material of at least one of the frame or inserts manufactured using 3D printing is selected from: Polylactic Acid (PLA), Polyethylene Terephthalate (PETG), nylon, or poly ether ether ketone (PEEK).

16. The device according to claim 14, wherein the material of at least one of the frame or inserts manufactured using 3D printing has anti-bacterial properties, such as copper nanoparticle impregnated PLA.

17. The device according to claim 14, wherein the material of the mouthguard is surgical grade resin.

18.-19. (canceled)

20. A method for the treatment of trismus, comprising:
using a device to exercise the jaw of a patient by placing arms of the device into the mouth opening of the patient such that the arms apply forces against the upper and lower jaw of the patient, the device comprising:
a frame including two arms connected to a base portion;
a first insert locatable in the frame, the first insert configured to cause the two arms to exert a first predetermined force in opposing outward directions relative to a central axis of the device; and
a second insert locatable in the frame in the same position as the first insert, the second insert configured to cause the two arms to exert a second predetermined force in opposing outward directions relative to the central axis of the device.

21. The method according to claim 20, wherein using the device includes asking the patient to repeatedly bite down on the arms of the device to actively stretch the muscles of mastication.

22. The method according to claim 20, wherein using the device to exercise the jaw of a patient comprises using the device with the first insert located in a first position in a first stage of treatment, then using the device with the first insert located in a second position in a second stage of treatment.

23. The method according to claim 22, further comprising using the device with the second insert located in the first position in a third stage of treatment, and then using the device with the second insert located in the second position in a fourth stage of treatment
